(19) United States
(12) Patent Application Publication
(10) Pub. No.: US 2005/0134856 A1
(43) Pub. Date: Jun. 23, 2005

(54) Automated bottle inspection appartatus and methods

(76) Inventor: Thomas Scott Rutledge, Sarnia (CA)

Correspondence Address: James W. Kerr;Labatt Brewing Company Limited, 303 Richmond Street, London, N6B 2H8, CA

(21) Appl. No.: 11/017,903

(22) Filed: Dec. 22, 2004

(30) Foreign Application Priority Data
Dec. 22, 2003 (CA) 2,453,935

(51) Int. Cl. G01N 21/00

(52) U.S. Cl. 356/427

(57) ABSTRACT

Apparatus is provided to conduct an automated foam pick operation on a production bottling line, to withdraw a biased sample of suspect bottles based on abnormal foam characteristics, which sample is then directed to an automated full bottle inspection operation that is set to monitor bottles at a statistically validated sampling rate. A method for conducting automated foam picking and candling in tandem operations is also provided.

### FIELD OF THE INVENTION

The present invention relates to improvements in automated bottle inspection apparatus and methods, and in particular to the statistical efficacy associated therewith in managing bottle inclusions, especially in beer packaging applications.

### BACKGROUND OF THE INVENTION

In bottle packaging line operations, one of the most important quality control/assurance operations relate to the management of foreign body inclusion risks. Perhaps the most common of inspection techniques is what is referred to in the brewing industry as “candling”. A general understanding of what is entailed in the inspection process is competently described in the 1995 printing of “Bottling and Canning of Beer”, by the Seibel Institute of Technology, and reproduced herein below.

“Fundamentals of Inspection: Actual inspection of the packages can only be as thorough as the ability of the inspectors and the available equipment permit. Thorough training of the inspectors and proper design and selection of the inspection lights are of obvious importance. Greater inspection efficiency can be obtained by selecting persons who have an aptitude for this type of work and then by training them properly. Scientific methods are now available for screening candidates. Good eyesight is one of the prerequisites of an efficient inspector. Incentive pay will add to the desire to do a good job. Inspection procedures and conditions can influence efficiency. Fatigue is one factor that must be considered because, while a person is fresh, his inspection efficiency may be 100 percent, but as the day wears on, fatigue sets in and his efficiency may drop to 80 percent or even lower. Inspectors must be rotated before fatigue develops so that inspection efficiency is maintained at a uniformly high level. The length of the inspection period must also be determined for a given operation. It is more tiring and difficult to inspect bottles moving past the inspection light at 200 per minute than at 100 per minute. Periods of inspection for the fast moving lines must, therefore, be shorter than those for slow lines. With high-speed lines, above 300 bottles per minute, the use of two inspection stations is desirable.

The training of inspectors should cover the following aspects:

1. A thorough understanding of what his duties are and what defects he is to look for.

2. Stressing the importance of the proper removal of the bottle from the line. As an inspector, he will merely detect bottles which appear undesirable. He must remove them without trying to decide whether his decision is right or not. Subsequent secondary inspection by another person can re-sort and isolate the acceptable from the unacceptable. A strong point to impress is that he must not move his eyes away from the inspection light because, if he does so, many bottles will pass unexamined.

3. Stressing the importance of concentrating on his job and not conversing with his associates.

The Inspection Light: In selecting the light itself, the following points must be considered since they have a direct bearing on the operator's efficiency.

1. The length of the inspection light should be sufficient to eliminate dark areas at the extremities, since a pronounced contrast will contribute to eye fatigue. The use of the circular magnifier glass is completely unsatisfactory because the glass distorts the bottle appearance, permits viewing of only several bottles at one time, and causes rapid fatigue of the eyes.

2. The light should be of the type or source, which reduces glare, and eyestrain. The most desirable type of light source is the fluorescent lamp. It produces a softer light with less glare and less shadow and provides three times the lumens per watt consumed as compared with incandescent lamps.

3. The intensity of the light should vary with different colored bottles and also with different bottle heights. A tall bottle requires light at a different level than a short bottle; green bottles require twice as much light for examination purposes than do flint bottles and amber bottles require five times as much. In full bottle examination, more light is needed at the base of the bottle, while in empty bottle examination an even distribution is desirable. Illumination from the bottom is also recommended. This can be done by replacing the chain conveyor with slim supporting rails for moving the bottles past the inspection light. Two 150 watt spot lights made of Pyrex glass provide the illumination, and a coarse mesh wire screen mounted just above the lights protects them from falling glass particles. Under-lighting illuminates the walls of the bottles as well as the base and the amount of light hitting the inspector's eyes is not increased to any great extent.

4. The color of the light source is also important. Use of colors complementary to the color of the bottle being examined seems to work out very well and fluorescent lamps are available in a limited number of colors such as red, green and blue. For example, in the case of a green bottle, a pink color is preferably used; for amber bottles, a sky blue color is desirable and with flint bottles, a soft green color is used. The location of one colored lamp in a bank of four or five white lamps makes a considerable difference and wide variations in the combination are possible. A green light is more penetrating for green bottle examination, but a quite red background makes the eyes more sensitive to green. The red light makes foreign objects stand out more acutely by making them appear black. In flint bottle examination, a colored light will make impurities show up as a colored rather than as a variation in light intensity. On the other hand, warm colors such as red, are eventually tiring and blue color tends to be depressing. Soft green light poses no problem.”

Another manual inspection technique is known as “foam picking”. This technique serves a variety of purposes—and in particular the detection of under filled bottles. However, foreign body inclusions often (although not always) also give rise to foam irregularities in bottled beer. In any case, these foam irregularities are detected visually, and bottles whose contents have an irregular foam profile are ejected by an operator from the packaging stream. Since not all inclusions result in foam production, “foam picking” per se is not reliable enough as a sole inspection method to screen out inclusions—in other words, the removal of foam picks does not provide the high levels of confidence that can be secured through the use of the “ideal” 100% automated inspection paradigm that is described herein below.

Nevertheless, by using foam picks as the source for samples that are then subjected to manual candling, the resulting sampling bias increases the likelihood of finding inclusions in the bottle population at large. Depending upon the types of glass and beer that are being produced, the statistically valid sample size that needs to be candled can be reduced significantly under typical operating conditions, and in any case the biased sample allows a statistical sample to be relatively small and manageable. Inspection rates of about 240 bottles an hour are sufficient to handle 60,000 bottles per hour line production speeds.

The costs and skill requirements for the necessary personnel, however, have inspired attempts at introducing automated candling-based equipment.

From a methodological point of view, there are two basic automated candling paradigms which can be applied to bottle inspection operations.

The “ideal” approach would entail an automated inspection of 100% of all finished product—and at current manufacturing outputs this can necessitate line inspection rates of 60,000 bottles per hour. In order to be compatible with this approach, a finished bottle inspection machine that is capable of running at these high line speeds is physically large (occupies a significant operational footprint within the plant), is expensive, and because only a very short window of time is available for inspection of each bottle, accuracy is absolutely critical. Attempts at making smaller machines to fit this inspection paradigm (e.g. the Krones “Linatronic” bottle inspection machine), has resulted in reduction in the sensitivity of the machine to bottle defects, with a corresponding loss in the accuracy of the inspection.

The automated alternative is a statistical sampling based automated inspection paradigm that entails a statistically validated, random sampling of finished product. At modern line speeds of 60,000 bottles per hour, this requires that about 2,000 bottles per hour be randomly sampled and inspected. This paradigm offers certain advantages over the ideal approach described in the preceding paragraph. More specifically, it does not require the same large scale inspection installation, since it only monitors production to confirm there are no sources of inclusions that are systemic to all production. Repeating defects (i.e. those that are occasioned over and over again as a result of some systemic processing problem), are of principle concern to packaging operations, and these can be monitored through a statistically valid sampling method using automated systems that are typically smaller and less expensive to install than those which are needed to be effective in delivering the ideal inspection paradigm described above. Nevertheless, even these smaller, less expensive systems must still handle a relatively large number of samples relative to the manual practices described hereinabove.

Attempts at producing automated candling systems have included those that have been made by RCA and Carlsberg. In the RCA device, the bottle was spun at high speed on a bottle turret, and then stopped at an inspection point intermediate between a light source/lens system, and a photo tube sensing device. The contents of the bottle continue to spin, and are illuminated as the light beam passes through the bottle. The moving particles (if any) disrupt the amount of light that reaches the photo tube sensors, which in turn generate an electrical signal representative of the presence of a foreign body inclusion. That signal is used to actuate a bottle-diverting device that removes the offending container from the packaging line.

In the Carlsberg device, the bottle was inverted, and then optically scanned for particulate materials moving under the influence of gravity. If the scan detected particles moving through the beer at or above a greater speed than a pre-set threshold value, then the bottle was presumed to contain objectionable foreign inclusions and rejected.

Both of these systems, however, were very limited in the number of bottles that could be screened—so much so in fact that they were an order of magnitude removed from what was required to deal with modem bottling line speeds. As a consequence, manual inspection has not been supplanted by automated candling practices.

Automated foam picking has also been attempted, largely because the advent of sufficient computing power and expert/artificial intelligence vision-analysis software systems permit mission critical foam analysis at speeds that at least in theory are sufficient to match modem high-speed bottling line operations. U.S. Pat. No. 5,414,778 relates to one such device—although its application appears to be primarily focused on the identification of “low fills” and “leakers”. The use of an automatic foam picking machine (e.g. Akitek's) does not provide 100% direct inspection for the defects; nor does it provide feedback that can be used to alarm production personnel to respond. Moreover, it has been reported that in comparative tests a skilled operator's manual inspection might typically and reliably reject at about the 0.4% level—while an automated foam-picking system rejects at about the 0.5 to 0.55% levels. This “overage” in the automated rejection rate to achieve the same effective overall reduction in foreign body inclusions represents a significant cost and an unjustified wastage of both product and packaging.

Accordingly there remains a need in the art to facilitate the automated management of beer bottles containing foreign inclusion bodies.

### SUMMARY OF THE INVENTION

The present invention relates to the combination of automated candling and foam picking devices to overcome the short comings associated therewith, while securing the advantages of automation over the more reliable manual methods, without compromising the overall reliability of the inspection process. More specifically, an automated foam pick machine is employed to bias, (by identifying abnormal foam characteristics in relation to a normal background foam character), the sample drawn from the production line. That sampling of bottles is then directed to an automated full bottle inspection operation that is set to monitor bottles at a statistically validated sampling rate. The potential benefits of the present invention include facilitating sizing the FBI candling capacity to match, (see “rate compatibility” herein below), the reduction number of bottles that must be candled—while at the same time providing for automated processing that compares more favorably with manual processes in terms of the efficacy/reliability of inspection. The typically less expensive FBI candling device that is then required, occupies less of an operational footprint in the (beer) production facility but provides a higher sensitivity than either an automated foam picker or an automated candling machine operating independently of one another.

The present invention pertains in one aspect thereof to a method for discriminating and sorting on a statistically predetermined basis between bottles whose contents include foreign inclusion bodies and those which do not. The method comprises the steps of: first introducing bottles from a high speed bottling line into an automated, high speed, foam picking means operable to inspect and foam pick bottles from all bottles being conveyed on said high speed bottling line and divert foam picked bottles there from; and then, secondly, passing said diverted foam picked bottles to a lower speed automated candling means for candling thereof and sorting candled, foam picked bottles on the basis of said candling into two streams, a first comprising a greater proportion of those having a foreign inclusion body contents and a second comprising a greater proportion of those whose contents do not contain foreign inclusion bodies.

In another aspect, the present invention can be embodied as a physically integrated machine, but in the context of component equipment that is currently commercially available the present invention is more likely to be embodied as a combination of separate machine functions arranged in tandem with one another in accordance with the teachings of the present specification.

The present invention also relates, in general, to an automated bottle inspection and handling system for discriminating and sorting on a statistical basis, (whether predetermined or not) between bottles whose contents include foreign inclusion bodies and those which do not. The combination of means provided for herein permits persons skilled in the art to effect automated processing of the inspection/handling operations in such a way as to facilitate quality control in high speed bottling line operations while at the same time approximating or improving upon the statistical discrimination associated with expert human operators.

In this sense, it is a feature of the invention to provide the advantages of adopting the benefits of an automated foreign inclusion body inspection/sorting operation while overcoming the high-cost/large-footprint issues variously associated with the automated candling equipment that would be needed to examine each of all of the bottles being processed on a high speed bottling line, (at least as compared with the statistical merits of human operators in a currently contemporaneous manual operation).

The system in accordance with the present invention comprises automated, high speed, foam picking means operable to inspect and foam pick bottles preferably from all bottles being conveyed on a given high speed bottling line. That foam picking means is further operable to divert foam picked bottles from the high speed bottling line, to a lower speed automated candling means. However, selective sampling from the high speed packaging line, is an optional alternative hereunder—whenever only some of the high speed packaging line bottles are (preferably on a random sampling basis), diverted to the foam pick means. Increased reliance on statistical methods and potentially less overall reliability result if this option is used.

The candling means is in turn operable to candle and sort these foam picked bottles into two streams. The first such stream comprises a greater proportion of those foam picked bottles including contents having foreign inclusion bodies. The second such stream comprises instead, a greater proportion of those foam picked bottles whose contents do not contain foreign inclusion bodies.

More particularly, the first stream contains a preponderance of the candled, foam picked bottles having foreign inclusion body contents. In a preferred form of the invention, the probability of the first stream comprising 99 or more percent of all of the bottles whose contents include foreign inclusion bodies, from the total number of bottles traversing the said high speed bottling line.

The automated high speed foam picking means and the lower speed automated candling means are preferably rate compatible. “Rate compatible” (and grammatical variations thereof) in this specification is a reference to the matching of the discriminatory capacity of the lower speed automated candling operation to the expected rejection rate from the high speed automated foam picking operation, under expectations of normal operating conditions within a given plant/production environment. As a rule the discriminatory capacity of the automated candling means will be significantly less, (and for the most part an order of magnitude less), than that of the automated foam picking means. Although bottles can be held in temporary staging operations to help match transient circumstances during which foam picked sample bottles accumulate faster that the capacity of the slower automated candling operation, the use of matched or rate compatible capacities of the two operations is generally preferred. Having said that, however, the foam picking means should preferably direct at least a minimum number of randomly selected sample bottles from the bottling line to the candling operation in circumstances where the number of foam picked rejects fall below that minimum number. Persons skilled in the art and in light of the present invention will, with the application of routine skill, be capable of ascertaining the rate compatibility of any selected combination of foam picking and candling means for application in a given plant's operational environment.

This combination makes it possible to overcome the rejection-rate problems associated automated foam picking, while constraining the sample size of the overall bottle population that must be subjected to full bottle inspection to ascertain/manage the risk of foreign body inclusions—and thereby allow small, less expensive full body automated inspection apparatus (or apparatus which requires a longer window of inspection opportunity) to be employed.

As suggested above, the rate at which foam picked bottles are in fact delivered from the automated high speed foam picking means to the rate compatible automated candling means can be modified to deal with transient operating conditions. In accordance with such an aspect of the present invention, there can be further provided a rate moderating means intermediate between the automated high speed foam picking means and the lower speed automated candling means, the rate moderating means being operable to reduce that rate at which foam picked bottles are delivered to the lower speed automated candling means from the automated high speed foam picking means.

In one mode of operation, the moderating means comprises staging means operable to temporarily hold back foam picked bottles delivered at a transient delivery rate exceeding a rate compatibility specified delivery rate, from the automated high speed foam picking means to said lower speed automated candling means, and to release held back bottles from the staging means when the delivery rate falls below the rate compatibility specified delivery rate. In this mode of moderating means operation, the number of foam picked bottles inspected by the automated candling means is equal to the number delivered from the foam picking means.

### INTRODUCTION TO THE DRAWINGS

FIG. 1 of the drawings appended hereto is a block process flow chart, schematically depicting a preferred functional interrelationship between a high speed bottling line in a brewery, and the present invention;

FIG. 2 is also a flow chart representation of the present invention, illustrating an alternate embodiment which includes statistical sampling by the automated foam picking means from the production line connecting the pasteurizer to the packaging and distribution systems;

FIG. 3 depicts a flow chart representation of an embodiment of the present invention in which rate modifying means comprising overflow staging means is provided between the automated foam picking and candling means; and,

FIG. 4 depicts another embodiment in accordance with the present invention, in which candling means by-pass and/or rejects are subjected to further scrutiny to aid in ascertaining what further quality control interdictions may be appropriate.

### DETAILED DESCRIPTION OF THE INVENTION

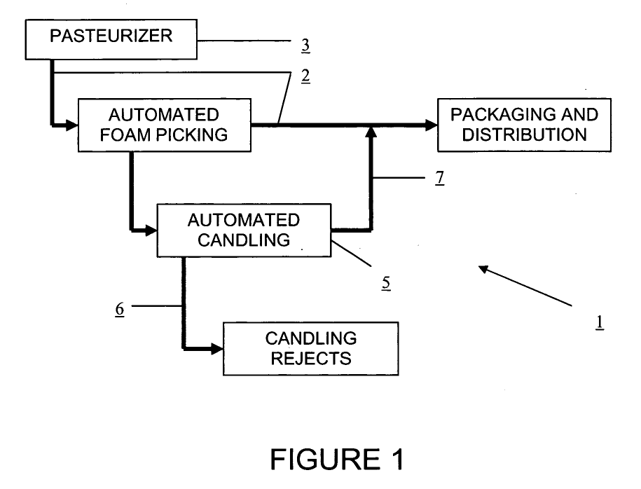

Referring now in particular to FIG. 1 of the drawings, an automated bottle inspection and handling system 1, is represented in relation to a high speed bottling line 2, down stream from a tunnel pasteurizer 3. System 1 comprises an automated, high speed, foam picking means 4 in combination with a lower speed automated candling means 5.

In operation, system 1 is operable for discriminating and sorting on a statistically predetermined basis between those bottles traversing bottling line 2 whose contents include foreign inclusion bodies from those which do not. High speed, foam picking means 4 is operable to inspect and foam pick bottles from all bottles being conveyed on said high speed bottling line 2 and divert foam picked bottles there from.

Foreign bodies, be they organic or glass, form nucleation points in beer. When a sealed beer bottle is tunnel pasteurized, these nucleation points create a temporary disassociation of the CO2 resulting in an abnormal foam collar. Foam picking whether manual or automated, is based on this principle. Automated foam pickers include systems commercially available from Akitek, (multi-point inspection stations foreign matter detection function “IFD-100”); see also U.S. Pat. No. 5,414,778.

Foam picked bottles that are diverted to the lower speed automated candling means 5 are candled and sorted into two streams. A first stream 6 comprises a greater proportion of those bottles which contain one or more foreign inclusion bodies. A second stream 7 of is comprised of bottles having a greater proportion of bottles whose contents do not contain foreign inclusion bodies—and in preferred forms of the present invention stream 6 contains at least a preponderance of the candled, foam picked bottles that contain foreign inclusion bodies, (e.g. the probability of stream 6 comprising ninety-nine (99) or more percent of all of the bottles whose contents include foreign inclusion bodies, from the total number of bottles traversing said high speed bottling line).

Automated full bottle inspection machines suitable for automated candling in the context of the present invention include Krones Linatronic 712-FBI.

In a preferred form of the present invention the automated high speed foam picking means and the lower speed automated candling means are rate compatible.

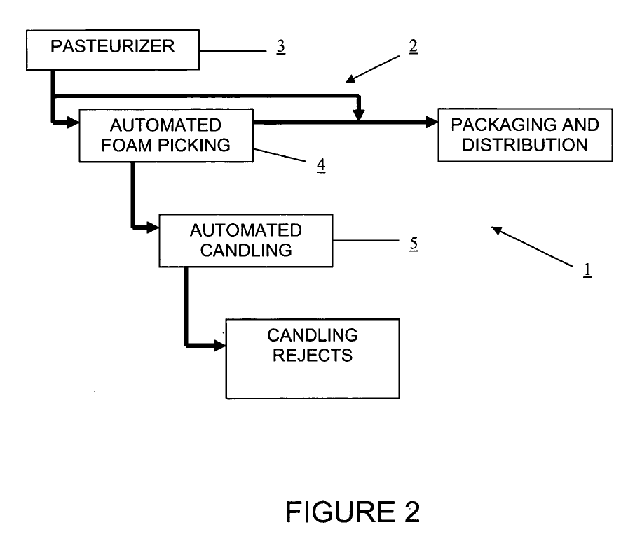

In the depicted embodiment of FIG. 2, the overall rate of inspection of the bottling line is based on diverting a (preferably random) statistical sample of bottles en route from the pasteurizer to downstream packaging and distribution operations. Rate compatibility between the foam picking and candling operations themselves however, remains the same as for other embodiments of the present invention.

Also, note that in general, rate compatibility between aggregate interconnected machines used in the foam picking and candling operations is a matter of operational capacity, regardless of whether the two operations are employed in combinatorial strategies of one-to-one; many-to-one; or, one-to-many distinct foam picking to candling machines.

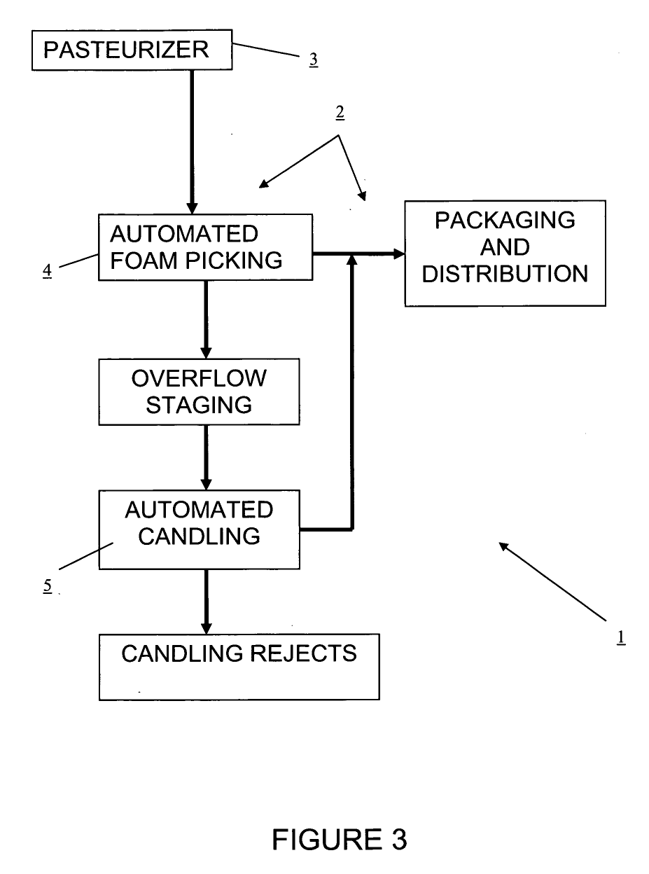

As shown in FIG. 3, the present invention can further include rate moderating means intermediate between the automated high speed foam picking means and the lower speed automated candling means. The rate moderating means being operable to reduce that rate at which foam picked bottles are delivered to the lower speed automated candling means from the automated high speed foam picking means. More specifically, the moderating means comprises staging means operable to temporarily hold back foam picked bottles delivered at a transient delivery rate exceeding a rate compatibility specified delivery rate, from said automated high speed foam picking means to said lower speed automated candling means, and to release held back bottles from said staging means when said delivery rate falls below said rate compatibility specified delivery rate. The staging means may operate in a variety of ways, including first-in/first-out, or last-in/first-out, or without any particular control over ordering. By way of example, Steeber et al, U.S. Pat. No. 6,550,602 relates to a staging device suitable for use in the present invention. It is within the contemplation of the present invention that monitoring of the numbers of bottles accumulating in an overflow staging means between the foam picking and candling means could be employed to alert plant operations personnel to the development of an exceptional problem, and/or to accelerate the evolution of the foam picking means characterization of background foam characteristics, particularly if the accumulation does not correspond to any increase in the number of concomitant candling rejects.

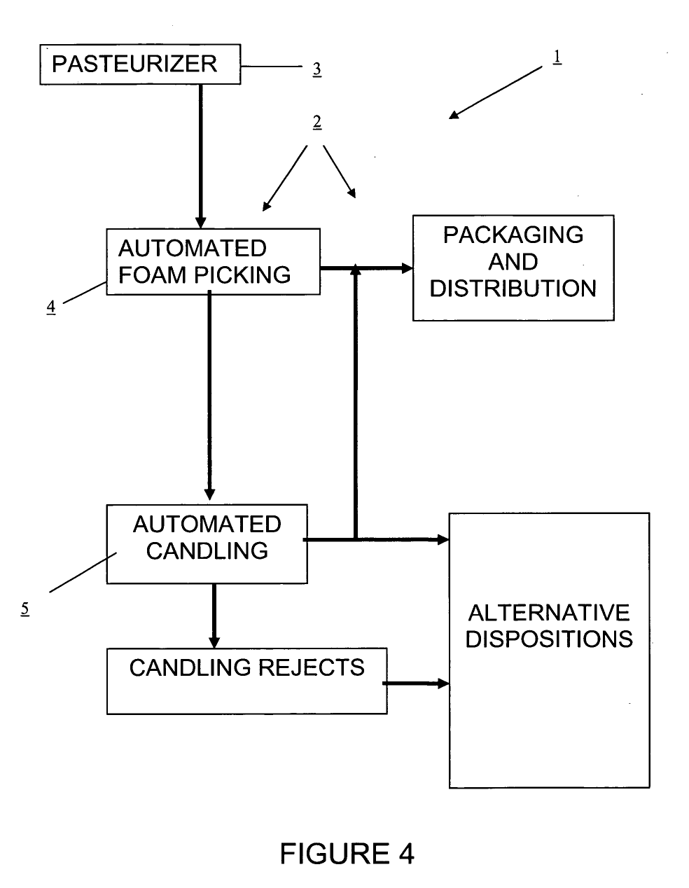

FIG. 4 of the appended drawings depicts a variation of the present invention which includes a pass-through (or other bypass) of the candling means to deal with production issues such as opaque bottles or liquids for which candling does not offer a conclusive disposition, (as in the case of foreign body inclusions which must then be detected using, for example, filtration of the liquid to separate out any such inclusions onto a highly contrasting filter paper where they can then be optically, (visually) detected. This particular form, (i.e. filtration) of alternative disposition clearly pre-empts the return of the bottle to the bottling line.

Alternative dispositions in general may also appertain to post-candling means inspected bottles (whether rejects or not) in situations where those rejected on the basis of foreign body inclusions need to be classified, or if other foam collar anomalies need to be further inspected to ascertain what differing forms of quality control interdictions may be desirable in upstream plant operations.

1. An automated bottle inspection and handling system for discriminating and sorting on a statistically predetermined basis between bottles whose contents include foreign inclusion bodies and those which do not, said system comprising automated, high speed, foam picking means operable to inspect and foam pick bottles from all bottles being conveyed on said high speed bottling line and divert foam picked bottles therefrom to a lower speed automated candling means for candling thereof and sorting candled, foam picked bottles on the basis of said candling into two streams, a first comprising a greater proportion of those having a foreign inclusion body contents and a second comprising a greater proportion of those whose contents do not contain foreign inclusion bodies.

2. The system according to claim 1, wherein said first stream contains a preponderance of said candled, foam picked bottles having foreign inclusion body contents.

3. The system according to claim 1, wherein said automated high speed foam picking means and said lower speed automated candling means are rate compatible.

4. The system according to claim 4, further including rate moderating means intermediate between said automated high speed foam picking means and said lower speed automated candling means, said rate moderating means being operable to reduce that rate at which foam picked bottles are delivered to said lower speed automated candling means from said automated high speed foam picking means.

5. The system according to claim 5, wherein said moderating means comprises staging means operable to temporarily hold back foam picked bottles delivered at a transient delivery rate exceeding a rate compatibility specified delivery rate, from said automated high speed foam picking means to said lower speed automated candling means, and to release held back bottles from said staging means when said delivery rate falls below said rate compatibility specified delivery rate.

6. A method for discriminating and sorting on a statistically predetermined basis between bottles whose contents include foreign inclusion bodies and those which do not, comprising:
introducing bottles from a high speed bottling line into an automated, high speed, foam picking means operable to inspect and foam pick bottles from all bottles being conveyed on said high speed bottling line and divert foam picked bottles there from, and then,
passing said diverted foam picked bottles to a lower speed automated candling means for candling thereof and sorting candled, foam picked bottles on the basis of said candling into two streams, a first comprising a greater proportion of those having a foreign inclusion body contents and a second comprising a greater proportion of those whose contents do not contain foreign inclusion bodies.
